(19) United States
(12) Patent Application Publication
(10) Pub. No.: US 2026/0184243 A1
(43) Pub. Date: Jul. 2, 2026

(54) COLD/WARM SENSATION CONTROL SEAT

(71) Applicants: HYUNDAI MOTOR COMPANY, Seoul (KR); Kia Corporation, Seoul (KR)

(72) Inventors: Gwan Sik KIM, Hwaseong-si (KR); Dong Gu KIM, Hwaseong-si (KR); Jang Hyeon LEE, Hwaseong-si (KR); Seok Min LEE, Hwaseong-si (KR); Kyong Hwa SONG, Hwaseong-si (KR); Deok Woo YUN, Hwaseong-si (KR)

(21) Appl. No.: 19/188,371

(22) Filed: Apr. 24, 2025

(30) Foreign Application Priority Data
Dec. 26, 2024 (KR) 10-2024-0197166

(51) Int. Cl. B60N 2/56; F25B 21/04

(52) U.S. Cl. CPC B60N 2/5692; B60N 2/5685; F25B 21/04; F25B 2700/15

(57) ABSTRACT

A cold/warm sensation control seat includes a heat transfer part including n-type heat transfer elements and p-type heat transfer elements that are alternately disposed in a pattern, a foam forming part including a first foam accommodating a partial region of the heat transfer part and a second foam disposed below the first foam and accommodating the remaining region of the heat transfer part, and a power source configured to supply power and having a pair of poles connected to which two opposite ends of the heat transfer part, respectively.

### CROSS-REFERENCE TO RELATED APPLICATION

This application claims priority to and the benefit of Korean Patent Application No. 10-2024-0197166, filed in the Korean Intellectual Property Office, on Dec. 26, 2024, the entire contents of which are incorporated herein by reference.

### TECHNICAL FIELD

The present disclosure relates to a cold/warm sensation control seat, and more particularly, to a cold/warm sensation control seat configured by coupling a pressure-sensitive heating carbon foam and a flexible thermoelectric film element.

### BACKGROUND

Seats of a vehicle may provide simultaneously controlling a cold sensation and a warm sensation. For example, vehicle seats may provide the cold/warm sensation with a combination of a heating wire and ventilation.

In some cases, a metal heating wire has a small volume and may provide a user with a warm sensation. In some cases, where the metal heating wire provides a warm sensation on an overall surface area of the seat when power is turned on, the amount of power consumption may be comparatively large due to no selective heating available. In some cases, there is a high risk of a fire when the heating wire is disconnected.

In some cases, carbon materials may be to reduce power consumption, improve stability, and provide various functionalities (selective heating, partial heating, and the like).

Ventilated seats may provide a cold sensation. In some cases, thermoelectric elements may be applied to implement cold-air seats. For instance, the thermoelectric element may not be involved in directly cooling the seat, but it uses the principle that an airflow loses heat while passing through a cooling part of the thermoelectric element. While a warm sensation control technology has various alternative technologies, a cold sensation control technology may have few alternative technology such as thermoelectric element technologies based on the Peltier effect. The thermoelectric element, however, may not be directly applied to the seat using the existing structure (hard ceramic substrate+bulk thermoelectric material) because of flexibility and stability issues.

Further, a technology may be appropriately combined with the existing warm sensation technology in order to simultaneously control the cold sensation and the warm sensation.

### SUMMARY

The present disclosure describes a cold/warm sensation control seat implemented by coupling a pressure-sensitive heating carbon foam and a flexible thermoelectric film element, thereby reducing power consumption and improving cold sensation efficiency and warm sensation efficiency.

According to one aspect of the subject matter described in this application, a temperature control seat includes a heat transfer part including n-type heat transfer elements and p-type heat transfer elements that are alternately disposed in a predetermined pattern and that have a predetermined length, where one end of each of the n-type heat transfer elements is connected to one end of one of the p-type heat transfer elements, a foam forming part including (i) a first foam that accommodates an upper portion of the heat transfer part and (ii) a second foam that is disposed below the first foam and accommodates a lower portion of the heat transfer part, and a power source configured to supply power to the heat transfer part, the power source having a pair of poles that are connected to two opposite ends of the heat transfer part, respectively.

Implementations according to this aspect can include one or more of the following features. For example, surfaces of the n-type heat transfer elements and the p-type heat transfer elements can be electrically insulated. In some implementations, the first foam can include a pressure-sensitive heating carbon foam that is coated with carbon nanotubes. In some examples, the second foam can include a urethane foam.

In some implementations, each of the n-type heat transfer elements can define a first heating wire, and each of the p-type heat transfer elements can define a second heating wire, where upper portions of the first and second heating wires in the first foam are bent and connected to each other, and lower portions of the first and second heating wires in the second foam are bent or curved and connected to each other.

In some implementations, the n-type heat transfer elements and the p-type heat transfer elements can be each a flexible thermoelectric film. In some examples, one side surface of each of the n-type heat transfer elements can be connected to one side surface of one of the p-type heat transfer elements, where the n-type heat transfer elements and the p-type heat transfer elements are arranged in a zigzag pattern. In some implementations, the n-type heat transfer elements and the p-type heat transfer elements define rhombic shapes that are arranged along a longitudinal direction of the heat transfer part, where a central region of a side surface of each of the n-type heat transfer elements is bent in a first direction along the longitudinal direction, and a central region of a side surface of each of the p-type heat transfer elements is bent in a second longitudinal direction opposite to the first direction. The central region of each of the n-type heat transfer elements is connected to the central region of one of the p-type heat transfer elements, where upper ends of one of the n-type heat transfer elements and the p-type heat transfer elements are connected to each other, and lower ends of one of the n-type heat transfer elements and the p-type heat transfer elements are connected to each other.

In some implementations, the pair of poles of the power source can include a positive pole and a negative pole, where the p-type heat transfer elements can include a p-type heat transfer element that is positioned at a first end of the heat transfer part, and the n-type heat transfer elements can include an n-type heat transfer element that is positioned at a second end of the heat transfer part. The upper portion of the heat transfer part can be configured to be cooled based on (i) the p-type heat transfer element at the first end of the heat transfer part being connected to the negative pole and (ii) the n-type heat transfer element at the second end of the heat transfer part being connected to the positive pole. In some examples, the power source can be connected to opposite ends of the pressure-sensitive heating carbon foam and configured to provide power to the pressure-sensitive heating carbon foam to thereby evaporate wet vapor that is produced while the upper portion of the heat transfer part is cooled.

In some implementations, the temperature control seat can include a switch configured to connect one of the p-type heat transfer elements positioned at a first end of the heat transfer part to one of the n-type heat transfer elements positioned at a second end of the heat transfer part, where the power source is connected to opposite ends of the first foam, and the upper portion of the heat transfer part is configured to be heated based on a pressure being applied to the heat transfer part. In some examples, the power source is connected to opposite ends of the first foam, and the pair of poles of the power source can include a positive pole and a negative pole, where the p-type heat transfer elements can include a p-type heat transfer element that is positioned at a first end of the heat transfer part, and the n-type heat transfer elements can include an n-type heat transfer element that is positioned at a second end of the heat transfer part. The upper portion of the heat transfer part can be configured to be heated based on each of (i) a pressure being applied to the heat transfer part and (ii) thermoelectricity being provided to the heat transfer part in which the p-type heat transfer element at the first end of the heat transfer part is connected to the positive pole, and the n-type heat transfer element at the second end of the heat transfer part is connected to the negative pole.

In some implementations, the temperature control seat includes a power meter that is connected to (i) one of the p-type heat transfer elements positioned at a first end of the heat transfer part and (ii) one of the n-type heat transfer elements positioned at a second end of the heat transfer part, where the power source is connected to opposite ends of the first foam. The upper portion of the heat transfer part can be configured to be heated based on a pressure being applied to the heat transfer part, and the lower portion of the heat transfer part can be configured to, while the upper portion of the heat transfer part is heated, generate power based on thermoelectricity being provided to the heat transfer part. In some examples, the power meter can be configured to measure the thermoelectricity generated in the lower portion of the heat transfer part.

As described above, in some implementations, the temperature control seat can be implemented by coupling the pressure-sensitive heating carbon foam and the flexible thermoelectric film element, thereby reducing the power consumption and improving the cold sensation efficiency and the warm sensation efficiency.

### BRIEF DESCRIPTION OF THE DRAWINGS

FIG. 1 is a top plan view illustrating an example of a structure of a cold/warm sensation control seat.

FIG. 2 is a perspective view illustrating the structure of the cold/warm sensation control seat of FIG. 1.

FIG. 3 is a perspective view illustrating an example of a structure of a cold/warm sensation control seat.

FIG. 4 is a perspective view illustrating an example of a structure of a cold/warm sensation control seat.

FIGS. 5 to 11 are top plan views illustrating example connection structures between the cold/warm sensation control seat of FIG. 1 and a power source.

FIGS. 12 to 17 are flowcharts sequentially illustrating example operating processes in accordance with states of the use of the cold/warm sensation control seat.

### DETAILED DESCRIPTION

Hereinafter, a cold/warm sensation control seat according to an implementation of the present disclosure will be described in more detail with reference to the accompanying drawings.

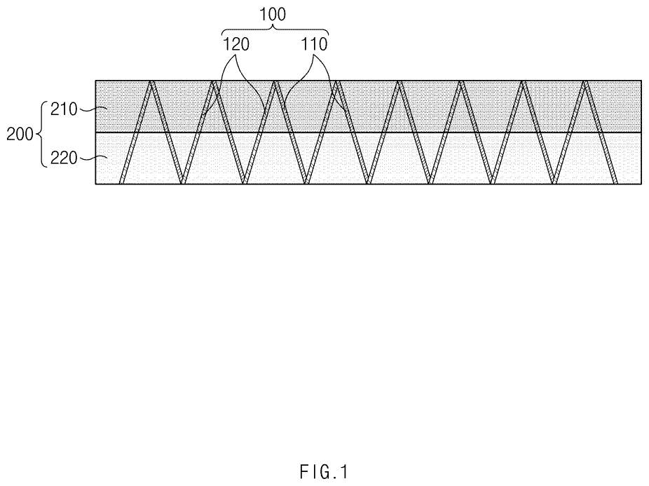

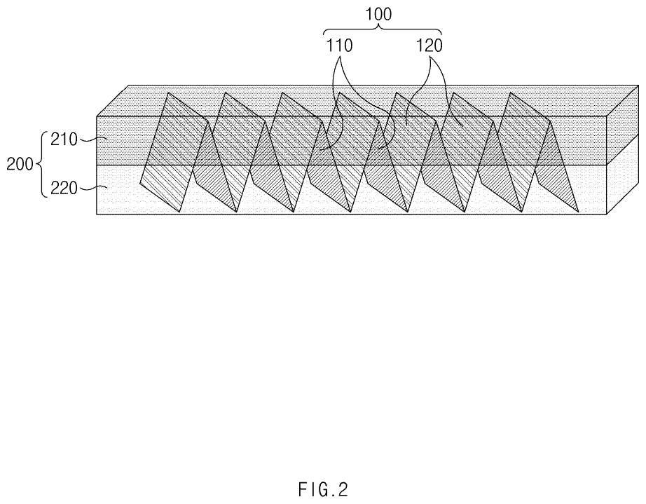

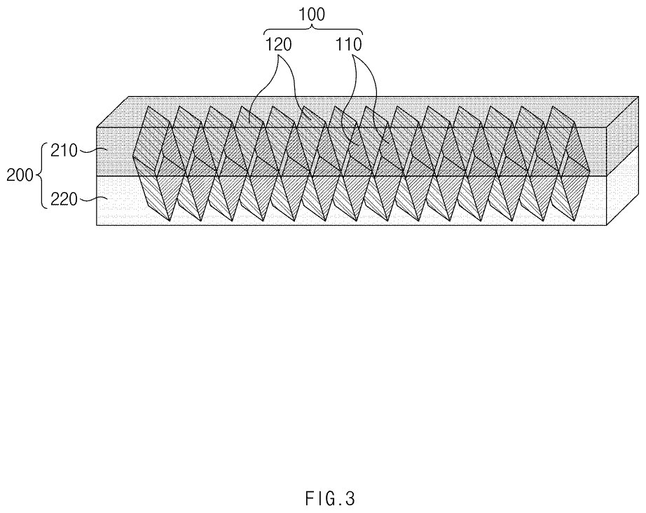

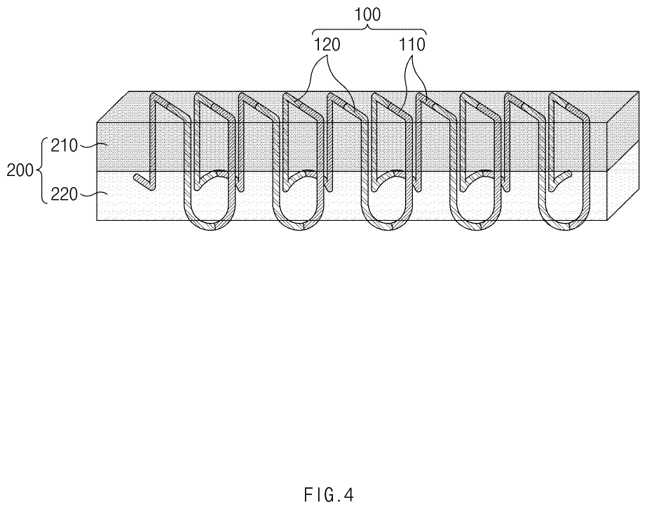

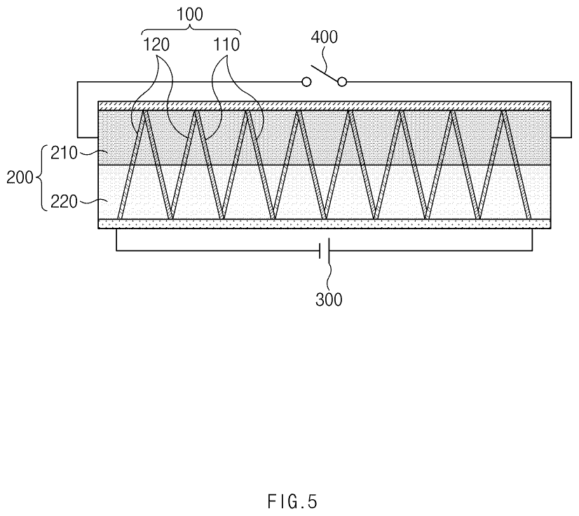

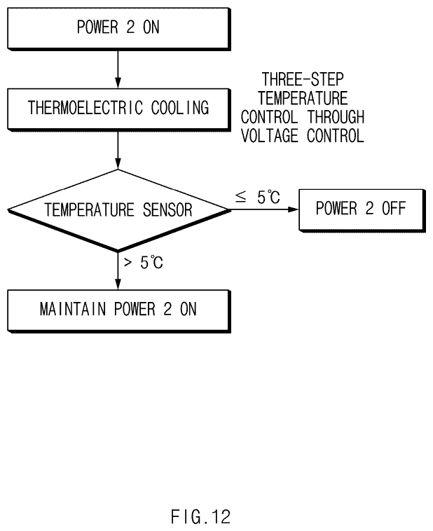

FIG. 1 is a top plan view illustrating an example of a structure of a cold/warm sensation control seat, FIG. 2 is a perspective view illustrating the structure of the cold/warm sensation control seat of FIG. 1, FIG. 3 is a perspective view illustrating an example of a structure of a cold/warm sensation control seat, FIG. 4 is a perspective view illustrating an example of a structure of a cold/warm sensation control seat, FIGS. 5 to 11 are top plan views illustrating example connection structures between the cold/warm sensation control seat of FIG. 1 and a power source in accordance with states of the use of the cold/warm sensation control seat, and FIGS. 12 to 17 are flowcharts sequentially illustrating example operating processes in accordance with states of the use of the cold/warm sensation control seat.

In some implementations, the cold/warm sensation control seat (temperature control seat) can broadly include: a heat transfer part 100 including n-type heat transfer elements 110 and p-type heat transfer elements 120 that are alternately disposed, where one end of the n-type heat transfer element 110 and one end of the p-type heat transfer element 120 are connected to each other, and the n-type heat transfer elements 110 and the p-type heat transfer elements 120 are repeatedly disposed in a predetermined pattern while defining a predetermined length. The cold/warm sensation control seat further includes a foam forming part 200 including a first foam 210 installed so that a partial region of the heat transfer part 100 positioned relatively upward is embedded in the first foam 210, and a second foam 220 disposed below the first foam 210 and installed so that the remaining region of the heat transfer part 100 positioned relatively downward is embedded in the second foam 220, and a power source 300 configured to supply power and having different poles to which two opposite ends of the heat transfer part 100 are respectively connected.

The cold/warm sensation control seat can adopt a coupling structure between a pressure-sensitive heating carbon foam and a flexible Peltier film element to cool or heat a seat for a vehicle, thereby providing a vehicle occupant with convenience, reducing power consumption, and quickly cooling or heating the seat.

The cold/warm sensation control seat can include the heat transfer part 100, the foam forming part 200, and the power source 300.

In some implementations, as illustrated in FIGS. 1 to 4, the heat transfer part 100 can serve to adjust a temperature of the seat in accordance with the necessity of the occupant by being substantially cooled or heated by receiving power. As described above, the heat transfer part 100 can be configured such that the n-type heat transfer elements 110 and the p-type heat transfer elements 120 are alternately disposed, one end of the n-type heat transfer element 110 and one end of the p-type heat transfer element 120 are connected to each other, and the n-type heat transfer elements 110 and the p-type heat transfer elements 120 are repeatedly disposed in a predetermined pattern to define a predetermined length. In some examples, n-type heat transfer elements 110 and the p-type heat transfer elements 120 can include semiconductors that are doped with n-type and p-type impurities, respectively. For example, n-type impurity material includes phosphorus or arsenic, and p-type impurity material includes boron, aluminum, or gallium.

In some implementations, the heat transfer part 100 can control a temperature of the seat by cooling or heating the seat by using the Peltier effect. The Peltier effect refers to a phenomenon in which when an electric potential difference is applied to two opposite sides of an object, heat flows together with an electric current, such that a temperature difference occurs between two opposite ends, i.e., a phenomenon in which when an electric current flows, a temperature difference occurs, such that one side is heated, and the other side is cooled.

The surfaces of the n-type heat transfer element 110 and the p-type heat transfer element 120, which constitute the heat transfer part 100, are insulated. Therefore, it can be possible to prevent an outer surface of the heat transfer part 100 from being exposed to the outside and subjected to electric conduction when the heat transfer part 100 is embedded in the foam forming part 200 and used for the seat. Therefore, it can be possible to prevent an injury to a human body.

As illustrated in FIGS. 1 to 3, the n-type heat transfer element 110 and the p-type heat transfer element 120 can each be provided in the form of a flexible thermoelectric film.

As illustrated in FIGS. 1 and 2, in the case of the heat transfer part 100 of the cold/warm sensation control seat, one side surface of the n-type heat transfer element 110 and one side surface of the p-type heat transfer element 120 are connected to each other, such that the heat transfer part 100 can be formed in a zigzag shape as a whole.

In case that the heat transfer part 100 is formed in a flexible thermoelectric film shape and a zigzag shape, the heat transfer part 100 is not damaged even though the cold/warm sensation control seat is formed to be curved.

Further, because the heat transfer part 100 is provided in the form of a film made of a flexible material, the heat transfer part 100 is not damaged even though an external force is applied to an upper side of the heat transfer part 100 or the heat transfer part 100 is bent.

In addition, it can be possible to easily adjust a density of the heat transfer part 100 installed to be embedded in the foam forming part 200 by adjusting a distance between the n-type heat transfer element 110 and the p-type heat transfer element 120.

As illustrated in FIG. 3, in the case of the heat transfer part 100 of the cold/warm sensation control seat, a central region of a plate surface of the n-type heat transfer element 110 is bent, a central region of a plate surface of the p-type heat transfer element 120 is bent, and two opposite ends of the n-type heat transfer element 110 and two opposite ends of the p-type heat transfer element 120 are connected to one another, such that an overall longitudinal section of the heat transfer part 100 can have a structure in which vertices of rhombic shapes are connected to one another.

Like the cold/warm sensation control seat, even the cold/warm sensation control seat can exhibit the effect of preventing damage to the heat transfer part 100 even though the cold/warm sensation control seat is formed to be curved.

Further, because the heat transfer part 100 is provided in the form of a film made of a flexible material, the heat transfer part 100 is not damaged even though an external force is applied to the upper side of the heat transfer part 100 or the heat transfer part 100 is bent.

In addition, it can be possible to easily adjust a density of the heat transfer part 100 installed to be embedded in the foam forming part 200 by adjusting a distance between the n-type heat transfer element 110 and the p-type heat transfer element 120.

As illustrated in FIG. 4, in the case of the heat transfer part 100 of the cold/warm sensation control seat, the n-type heat transfer element 110 and the p-type heat transfer element 120 can each be provided in the form of a heating wire so that upper portions of the heating wires are bent vertically and connected to one another, and lower portions of the heating wires are bent to be curved and connected to one another.

In the case of the cold/warm sensation control seat in which the heat transfer part 100 is provided in the form of a heating wire, costs and time can be reduced for manufacturing the heat transfer part 100, such that the cold/warm sensation control seat can be quickly manufactured.

In some examples, the foam forming part 200 includes the first foam 210 installed so that the partial region of the heat transfer part 100 positioned relatively upward is embedded in the first foam 210, and the second foam 220 disposed below the first foam 210 and installed so that the remaining region of the heat transfer part 100 positioned relatively downward is embedded in the second foam 220.

The first foam 210 can be formed as a pressure-sensitive heating carbon foam coated with carbon nanotubes. As a method of coupling the pressure-sensitive heating carbon foam and the heat transfer part 100 formed as the flexible thermoelectric film, a method of inserting the flexible thermoelectric film into the pressure-sensitive heating carbon foam can be used, or a method of performing injection-molding on the pressure-sensitive heating carbon foam into which the flexible thermoelectric film is inserted can be used.

Because the pressure-sensitive heating carbon foam is coated with carbon nanotubes, the contact between the carbon nanotubes is increased by pressure when the pressure is applied. Therefore, the amount of electric current is increased, and the resistance is decreased, such that Joule heating occurs, which generates heat.

Further, it is effective that a coating solution for applying the carbon nanotubes during the process of manufacturing the pressure-sensitive heating carbon foam contains a dehumidifying agent such as calcium chloride, such that moisture can be absorbed to some extent when wet vapor is generated.

It is effective that the second foam 220 is formed as a urethane foam, thereby securely supporting the heat transfer part 100 installed to be embedded in the second foam 220 and preventing damage to the heat transfer part 100 caused by an external force from the outside.

FIGS. 5 to 11 are top plan views illustrating the connection structures between the cold/warm sensation control seat and the power source in accordance with the states of the use of the cold/warm sensation control seat.

As illustrated in FIG. 5, in order to cool the upper portion of the heat transfer part 100, the p-type heat transfer element 120 positioned at one end of the heat transfer part 100 can be connected to a negative pole of the power source 300, and the n-type heat transfer element 110 positioned at the other end of the heat transfer part 100 can be connected to a positive pole of the power source 300.

In case that the p-type heat transfer element 120 is connected to the negative pole of the power source 300 and the n-type heat transfer element 110 is connected to the positive pole of the power source 300, the upper portion of the heat transfer part 100 is cooled by the Peltier effect, and heat with 50° C. or less is generated from the lower portion of the heat transfer part 100. The heat generated from the lower portion of the heat transfer part 100 is absorbed by the urethane foam, i.e., the second foam 220, such that the heat can be prevented from being transferred to the upper side of the cooled heat transfer part 100, thereby improving the cooling efficiency.

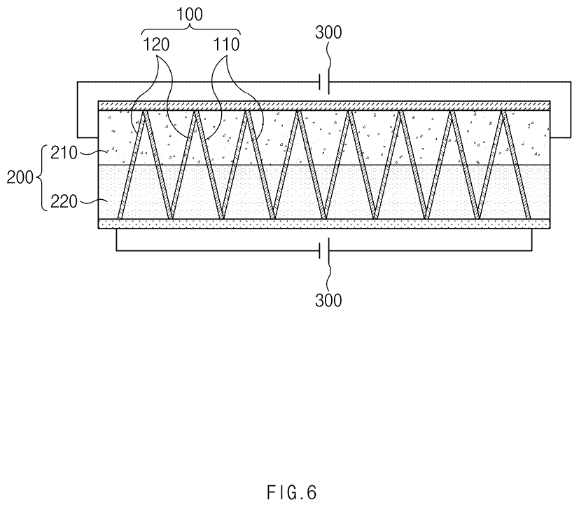

Further, as illustrated in FIG. 6, in order to evaporate wet vapor produced when the upper portion of the heat transfer part 100 is cooled, the power source is also connected to two opposite ends of the pressure-sensitive heating carbon foam, i.e., the first foam 210 and supplies power to the pressure-sensitive heating carbon foam, such that heat is generated to some extent from the upper portion of the heat transfer part 100, and the wet vapor can be evaporated and removed.

In addition, the coating solution for applying the carbon nanotubes during the process of manufacturing the pressure-sensitive heating carbon foam contains the dehumidifying agent such as calcium chloride, such that when wet vapor is generated, moisture can be absorbed to some extent, and a rate of absorbing the wet vapor can be increased.

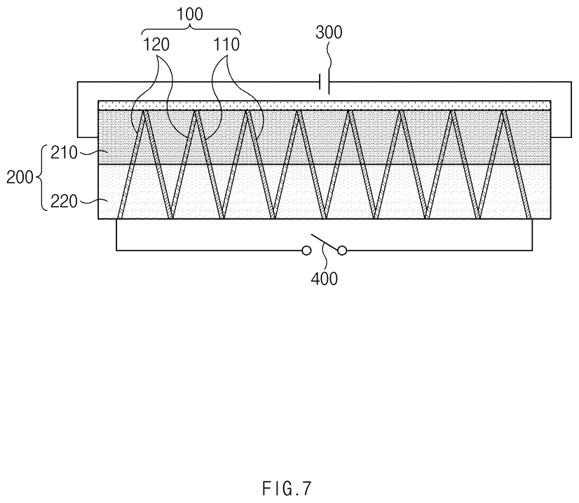

As illustrated in FIG. 7, in order to heat the upper portion of the heat transfer part 100 in a pressure-sensitive manner, the power source 300 can be connected to the two opposite ends of the first foam 210, and the p-type heat transfer element 120 positioned at one end of the heat transfer part 100 and the n-type heat transfer element 110 positioned at the other end of the heat transfer part 100 can be connected to a switch 400.

When the power source 300 is connected to the two opposite ends of the first foam 210 and supplies power to the first foam 210, a voltage is applied to the pressure-sensitive heating carbon foam that constitutes the first foam 210, such that heat is generated.

In some cases, where no pressure is applied to the pressure-sensitive heating carbon foam, a higher voltage may be applied in comparison with a case in which the pressure is applied by pressing. This state can be used to remotely turn on the vehicle or heat a steering wheel in advance.

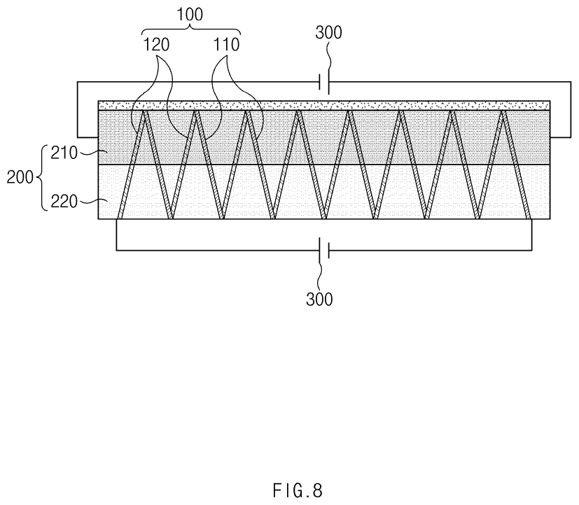

As illustrated in FIG. 8, in order to simultaneously heat the upper portion of the heat transfer part 100 in a pressure-sensitive manner and heat the upper portion of the heat transfer part 100 in a thermoelectric manner, the power source can be connected to the two opposite ends of the first foam 210, the p-type heat transfer element 120 positioned at one end of the heat transfer part 100 can be connected to the positive pole of the power source 300, and the n-type heat transfer element 110 positioned at the other end of the heat transfer part 100 can be connected to the negative pole of the power source 300.

That is, in order to heat the upper portion of the heat transfer part 100 in a thermoelectric manner in the opposite way to the connection structure of the power source 300 made to cool the upper portion of the heat transfer part 100 illustrated in FIG. 5, the p-type heat transfer element 120 can be connected to the positive pole of the power source 300, and the n-type heat transfer element 110 positioned at the other end of the heat transfer part 100 can be connected to the negative pole of the power source 300, such that heat is generated from the upper portion of the heat transfer part 100 in the opposite way by the Peltier effect.

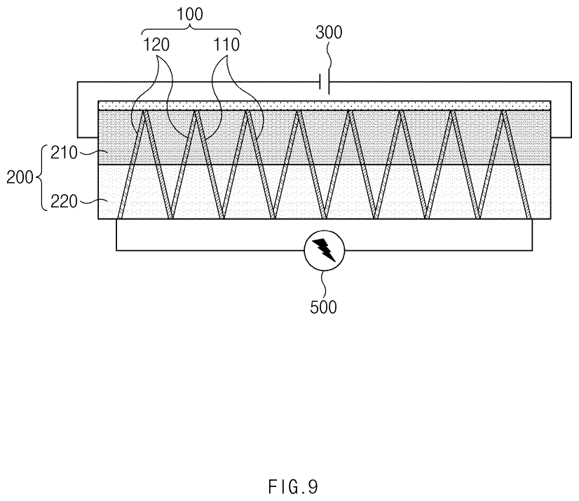

As illustrated in FIG. 9, in order to simultaneously heat the upper portion of the heat transfer part 100 in a pressure-sensitive manner and generate power at the lower portion of the heat transfer part 100 in a thermoelectric manner, the power source can be connected to the two opposite ends of the first foam 210, and a power meter 500 can be installed on the p-type heat transfer element 120 positioned at one end of the heat transfer part 100 and the n-type heat transfer element 110 positioned at the other end of the heat transfer part 100.

This configuration generates electric power by using the Seebeck effect that generates power in a thermoelectric manner by inducing a temperature difference between the upper and lower portions of the foam forming part 200 by pressure-sensitive heating, and the configuration can use the generated electric power, thereby improving the energy efficiency.

The power meter 500 refers to a device that identifies whether power generation is performed. It is effective that when the power meter 500 identifies that the power generation is performed, a capacitor can be installed to accumulate the generated electrical energy in the capacitor, and the accumulated electrical energy can be separately used.

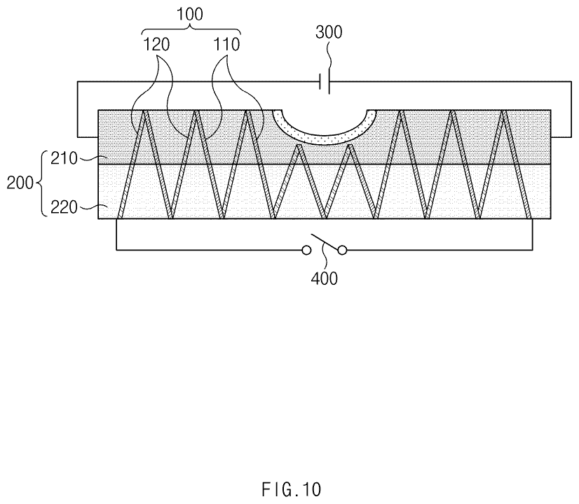

As illustrated in FIG. 10, in the cold/warm sensation control seat, the first foam 210 disposed at the upper side of the foam forming part 200 is formed as the pressure-sensitive heating carbon foam. When the first foam 210 is partially pushed and pressed in a state in which power is applied to the two opposite sides of the first foam 210, heat can be selectively generated only from a portion to which the pressure is applied.

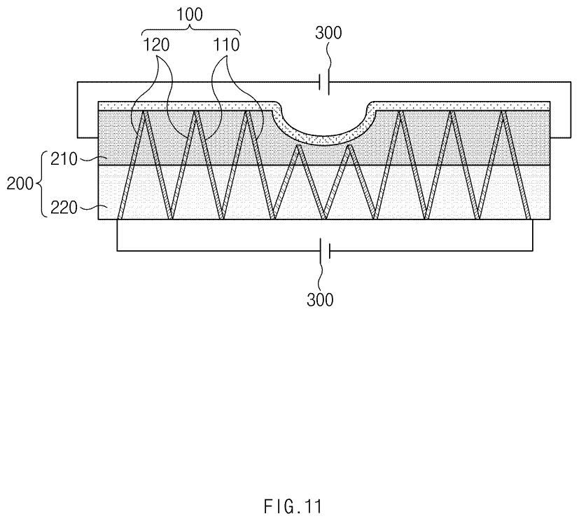

Further, as illustrated in FIG. 11, as described above, in order to generate heat simultaneously in a pressure-sensitive manner and a thermoelectric manner, the power source is connected to the n-type heat transfer element 110 and the p-type heat transfer element 120, and the entire first foam 210 is heated, such that the portion to which the pressure is applied can be heated to a relatively higher temperature.

FIGS. 12 to 17 are the flowcharts sequentially illustrating the operating processes in accordance with the states of the use of the cold/warm sensation control seat.

FIG. 12 illustrates a basic cold sensation operating process that can perform three-step temperature control. When power is applied to the power source 300, the first foam 210, which is the upper portion of the foam forming part 200, is cooled in a thermoelectric manner by the Peltier effect. When the lowered temperature is 5° C. or less, the power connection is cut off. When the temperature exceeds 5° C., power is consistently supplied, the cooling is performed in a thermoelectric manner.

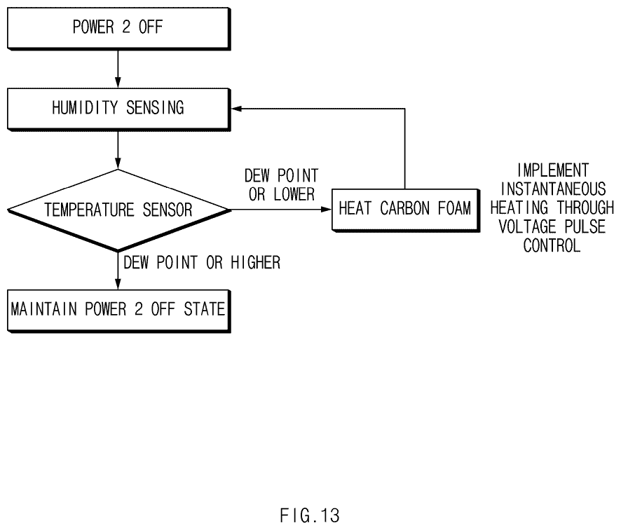

FIG. 13 illustrates a process of removing moisture when the moisture is produced by the cold sensation. As described above, because moisture is not produced in case that a temperature of outside air is a dew point or higher in a state in which the supply of power is cut off after the cooling is performed, the state in which power is turned off is consistently maintained. Further, because moisture is produced in case that a temperature of outside air is lower than the dew point, power is supplied to the first foam 210, and the first foam 210 generates heat, such that the produced moisture can be evaporated.

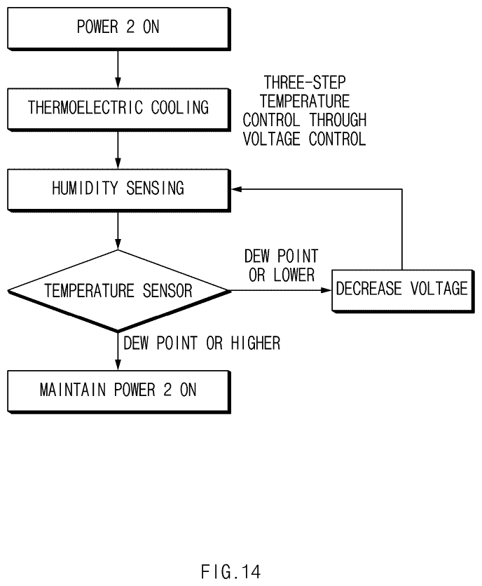

FIG. 14 illustrates a process of controlling the cooling to prevent the occurrence of moisture. Only in case that a temperature of outside air is lower than the dew point after whether moisture is produced is determined by the method illustrated in FIG. 13, a process of removing moisture by decreasing a voltage of power to be supplied to the first foam 210 is repeated. When the moisture is completely removed, the supply of power is cut off, such that the cooling control can be performed.

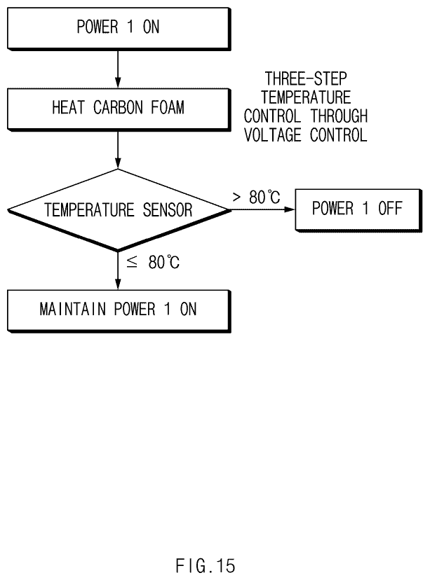

FIG. 15 illustrates a basic warm sensation operating process that can perform three-step temperature control. The power source 300 supplies power in a direction opposite to the direction in which the power is supplied when the cooling is performed, such that the first foam 210 generates heat. When the heating temperature exceeds 80° C., the supply of power is cut off. When the heating temperature is 80° C. or less, the power is consistently supplied, such that the warm sensation operation can be performed.

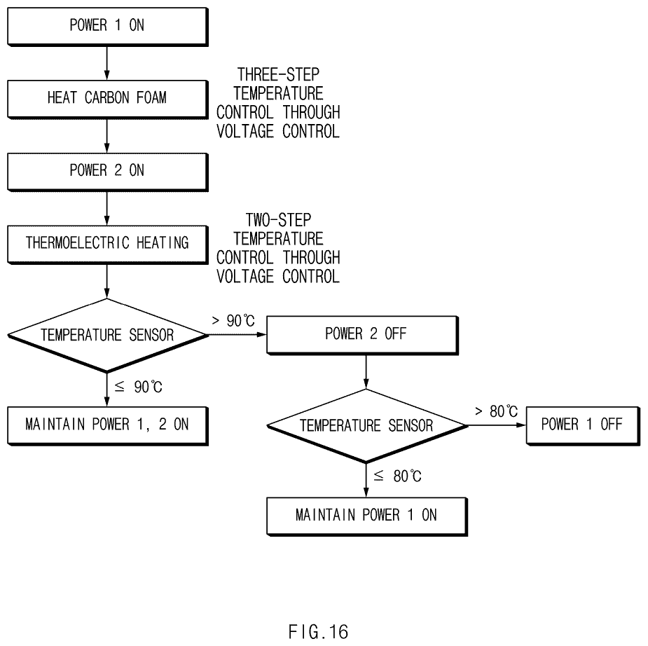

FIG. 16 illustrates a warm sensation operating process that performs five-step temperature control. The three-step temperature control is performed by using power supplied from the power source 300, the thermoelectric heating is performed by supplying power to the first foam 210, and two-step temperature control is additionally performed, such that the five-step temperature control can be performed.

In some cases, when the temperature of the heat generated from the heat transfer part 100 exceeds 90° C., the supply of power to the first foam 210 is cut off. Thereafter, the supply of power from the power source 300 is also cut off until the temperature of the heat generated from the heat transfer part 100 becomes 80° C. When the temperature of the heat generated from the heat transfer part 100 is lower than 80° C., the power to the power source 300 is turned on, and the power is supplied again, such that the heat transfer part 100 is heated.

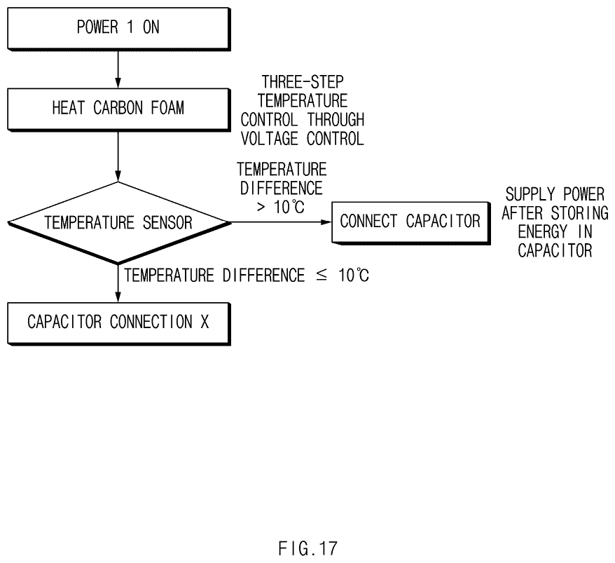

FIG. 17 illustrates a configuration for improving energy efficiency by generating electric energy while performing the basic warm sensation operation. When a temperature difference between the first foam 210 and the second foam 220, which constitute the foam forming part 200, exceeds 10° C. after the power source 300 supplies power to heat the first foam 210, the capacitor is connected, and energy accumulation is performed as the generated electric energy is stored in the capacitor, such that the accumulated energy can be used later.

The cold/warm sensation control seat configured as described above is implemented by coupling the pressure-sensitive heating carbon foam and the flexible thermoelectric film element, thereby reducing the power consumption and improving the cold sensation efficiency and the warm sensation efficiency.

While the implementations, which can be implemented by the present disclosure, have been described above, the implementations are just illustrative and not intended to limit the present disclosure. It can be appreciated by those skilled in the art that various modifications and applications, which are not described above, can be made to the present implementation without departing from the intrinsic features of the present implementation. For example, the respective constituent elements specifically described in the implementations can be modified and then carried out. Further, it should be interpreted that the differences related to the modifications and applications are included in the scope of the present disclosure defined by the appended claims.

What is claimed is:

1. A temperature control seat comprising:
a heat transfer part comprising n-type heat transfer elements and p-type heat transfer elements that are alternately disposed in a predetermined pattern and that have a predetermined length, wherein one end of each of the n-type heat transfer elements is connected to one end of one of the p-type heat transfer elements;
a foam forming part comprising (i) a first foam that accommodates an upper portion of the heat transfer part and (ii) a second foam that is disposed below the first foam and accommodates a lower portion of the heat transfer part; and
a power source configured to supply power to the heat transfer part, the power source having a pair of poles that are connected to two opposite ends of the heat transfer part, respectively.

2. The temperature control seat of claim 1, wherein surfaces of the n-type heat transfer elements and the p-type heat transfer elements are electrically insulated.

3. The temperature control seat of claim 1, wherein the first foam comprises a pressure-sensitive heating carbon foam that is coated with carbon nanotubes.

4. The temperature control seat of claim 1, wherein the second foam comprises a urethane foam.

5. The temperature control seat of claim 1, wherein each of the n-type heat transfer elements defines a first heating wire, and each of the p-type heat transfer elements defines a second heating wire,
wherein upper portions of the first and second heating wires in the first foam are bent and connected to each other, and
wherein lower portions of the first and second heating wires in the second foam are bent or curved and connected to each other.

6. The temperature control seat of claim 1, wherein the n-type heat transfer elements and the p-type heat transfer elements are each a flexible thermoelectric film.

7. The temperature control seat of claim 6, wherein one side surface of each of the n-type heat transfer elements is connected to one side surface of one of the p-type heat transfer elements, and
wherein the n-type heat transfer elements and the p-type heat transfer elements are arranged in a zigzag pattern.

8. The temperature control seat of claim 6, wherein the n-type heat transfer elements and the p-type heat transfer elements define rhombic shapes that are arranged along a longitudinal direction of the heat transfer part,
wherein a central region of a side surface of each of the n-type heat transfer elements is bent in a first direction along the longitudinal direction, and a central region of a side surface of each of the p-type heat transfer elements is bent in a second longitudinal direction opposite to the first direction,
wherein the central region of each of the n-type heat transfer elements is connected to the central region of one of the p-type heat transfer elements, and
wherein upper ends of one of the n-type heat transfer elements and the p-type heat transfer elements are connected to each other, and lower ends of one of the n-type heat transfer elements and the p-type heat transfer elements are connected to each other.

9. The temperature control seat of claim 3, wherein the pair of poles of the power source comprise a positive pole and a negative pole,
wherein the p-type heat transfer elements comprise a p-type heat transfer element that is positioned at a first end of the heat transfer part,
wherein the n-type heat transfer elements comprise an n-type heat transfer element that is positioned at a second end of the heat transfer part, and
wherein the upper portion of the heat transfer part is configured to be cooled based on (i) the p-type heat transfer element at the first end of the heat transfer part being connected to the negative pole and (ii) the n-type heat transfer element at the second end of the heat transfer part being connected to the positive pole.

10. The temperature control seat of claim 9, wherein the power source is connected to opposite ends of the pressure-sensitive heating carbon foam and configured to provide power to the pressure-sensitive heating carbon foam to thereby evaporate wet vapor that is produced while the upper portion of the heat transfer part is cooled.

11. The temperature control seat of claim 3, further comprising:
a switch configured to connect one of the p-type heat transfer elements positioned at a first end of the heat transfer part to one of the n-type heat transfer elements positioned at a second end of the heat transfer part,
wherein the power source is connected to opposite ends of the first foam, and
wherein the upper portion of the heat transfer part is configured to be heated based on a pressure being applied to the heat transfer part.

12. The temperature control seat of claim 3, wherein the power source is connected to opposite ends of the first foam,
wherein the pair of poles of the power source comprise a positive pole and a negative pole,
wherein the p-type heat transfer elements comprise a p-type heat transfer element that is positioned at a first end of the heat transfer part, and the n-type heat transfer elements comprise an n-type heat transfer element that is positioned at a second end of the heat transfer part, and
wherein the upper portion of the heat transfer part is configured to be heated based on each of (i) a pressure being applied to the heat transfer part and (ii) thermoelectricity being provided to the heat transfer part in which the p-type heat transfer element at the first end of the heat transfer part is connected to the positive pole, and the n-type heat transfer element at the second end of the heat transfer part is connected to the negative pole.

13. The temperature control seat of claim 3, further comprising:
a power meter that is connected to (i) one of the p-type heat transfer elements positioned at a first end of the heat transfer part and (ii) one of the n-type heat transfer elements positioned at a second end of the heat transfer part,
wherein the power source is connected to opposite ends of the first foam,
wherein the upper portion of the heat transfer part is configured to be heated based on a pressure being applied to the heat transfer part, and
wherein the lower portion of the heat transfer part is configured to, while the upper portion of the heat transfer part is heated, generate power based on thermoelectricity being provided to the heat transfer part.

14. The temperature control seat of claim 13, wherein the power meter is configured to measure the thermoelectricity generated in the lower portion of the heat transfer part.
